(19) United States
(12) Patent Application Publication
(10) Pub. No.: US 2006/0256679 A1
(43) Pub. Date: Nov. 16, 2006

(54) LASER POWER CONTROLLING METHOD FOR RECORDING DATA AND RELATED APPARATUS

(76) Inventors: Kuang-Jung Chang, Taipei City (TW); Pao-Ping Ma, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/908,402

(22) Filed: May 10, 2005

(51) Int. Cl. G11B 7/12

(52) U.S. Cl. 369/47.5

(57) ABSTRACT

A laser power controlling method for controlling power outputted from a laser to record data onto an optical disc and a related apparatus are disclosed. The laser power controlling method includes writing data onto the optical disc according to a characteristic of a write power of the laser, halting writing the data at a stopping point, evaluating the data recorded on the optical disc for generating a first evaluating result, adjusting the characteristic of the write power according to the first evaluating result, and utilizing the laser to restart writing data onto the optical disc from a starting point according to an adjusted characteristic of the write power, wherein there is a gap between the starting point and the stopping point.

### BACKGROUND

The present invention relates to a laser controlling method and a related apparatus, and more particularly, to a laser power controlling method and apparatus capable of stopping recording of data for adjusting the laser power and restarting recording of data.

A related art compact disc recorder has a pick-up head, which emits a laser beam to heat the recording layer of a compact disc for storing data in a digital format. Base on the well-known disc specification, a pit on the compact disc is defined to represent “0”, and a land of the compact disc is defined to represent “1”. Unfortunately, different compact discs have varying energy absorption characteristics of the laser beam due to different properties of the recording layers. For example, when the same laser beam (i.e., the same laser power), illuminates DVD-R discs taken from different manufacturers, different levels of etching occur. As a result, when a compact disc is manufactured, a desired write power for this compact disc is pre-recorded in a lead-in area of the compact disc to serve as a reference during a recording session. Additionally, compact disc recorders produced by various manufacturers support an Optimum Power Control (OPC) procedure and a Running Optimum Power Control (ROPC) procedure to ensure accuracy of the recording results. Details of the preferred method for performing the OPC and ROPC procedures can be found in any optical disc specifications and are summarized as follows.

First, utilizing either the constant linear velocity (CLV) mode or the constant angular velocity (CAV), the OPC procedure typically employs numerous different write power settings to perform a writing test procedure in a Power Calibration Area (PCA) by writing a plurality of test data according to these different write powers. Next, the OPC procedure retrieves the test results recorded on the optical disc and by evaluating the test data selects a suitable write power from the different write powers to be an optimum write power of the optical disc.

Typically, after performing the OPC procedure, the ROPC procedure is performed. This is necessary due to inconsistent characteristics of the compact disc itself, for example, dust on the optical disc, an unexpected influence making the write power unstable, or a temperature variance influencing operation of the pick-up head. When the optical disc recorder writes data onto the optical disc the ROPC procedure is utilized to perform an on-line adjustment of the optimum power determined by the OPC procedure according to a target reflected pulse level stored in the lead-in area of the optical disc. Furthermore, when the compact disc recorder writes data onto the optical disc, the pick-up head emits an incident write pulse to heat the optical disc. Taking a DVD-R disc as an example, the incident write pulse will be reflected to form a reflected pulse through the optical disc, and a reflected pulse level of the reflected pulse. According to the Orange Book this is called a β-level and it represents the depth of etching on the DVD-R disc. As the ROPC procedure is performed, the optical disc recorder compares the reflected pulse level to the target reflected pulse level pre-recorded on the optical disc to adjust the optimum power of the emitting laser and to maintain the reflected pulse level at a suitable range so as to ensure the accuracy of the data recorded on the optical disc.

However, the obtained optimum power fails to characterize other information about the laser power, such as the overdrive (OD) power and OD length, when performing the related art OPC procedure. Please refer to FIG. 1, which is a schematic diagram of a related art incident write pulse 10. As shown in FIG. 1, P_{W} denotes the write power of the incident write pulse 10, P_{OD} denotes the OD power of the incident write pulse 10, and L_{OD} denotes the OD length of the incident write pulse 10. When performing the conventional OPC procedure, the temperature or the delay of a transmitting circuit of the optical disc recorder will influence the OD power and distort the result of the OPC procedure. Additionally, during the ROPC procedure, the Signal to Noise Ration (SNR) of the reflected pulse level utilized to adjust the optimum power worsens when the optical disc recorder operates at a high recording speed. Furthermore, the reflected pulse level may also be incorrectly detected because of environment factors, such as the tilt of the optical disc. The ROPC procedure, therefore, adjusts the optimum power incorrectly.

### SUMMARY

It is therefore one of the objectives of the claimed invention to provide a laser power controlling method and apparatus capable of stopping recording of data for adjusting the laser power and restarting recording data, to solve the above-mentioned problem.

According to the claimed invention, a laser power controlling method for controlling power outputted from a laser to record data onto an optical disc is disclosed. The laser power controlling method comprises writing data onto the optical disc according to a characteristic of a write power outputted from the laser, halting writing of the data at a stopping point prior to an end of the optical disc, evaluating the data recorded on the optical disc for generating a first evaluating result, adjusting the characteristic of the write power outputted from the laser according to the first evaluating result, and utilizing the laser to restart writing data onto the optical disc from a starting point according to an adjusted characteristic of the write power, wherein the starting point is located between the stopping point and the end of the optical disc, and there is a gap between the starting point and the stopping point.

According to the claimed invention, a laser power control method for controlling power outputted from a laser to record data onto an optical disc is disclosed. The laser power controlling method comprises writing a plurality of test data on a optical disc according to a plurality of candidate power characteristics, respectively, then evaluating the test data recorded on the optical disc corresponding to the candidate power characteristics, respectively, to generate a first evaluating result, selecting one of the candidate power characteristics to be a characteristic of an write power according to the first evaluating result, and writing data onto the optical disc according to the characteristic of the write power outputted from the laser, wherein the plurality of candidate power characteristics and the characteristic of the write power are utilized to determine an overdrive power.

According to the claimed invention, a laser power controlling apparatus for controlling power outputted from a laser to record data onto an optical disc is disclosed. The laser power controlling apparatus comprises a laser modulating circuit, electrically connected to the laser, for driving the laser to write data onto the optical disc according to a characteristic of a write power outputted from the laser; a recording stopper, electrically connected to the laser modulating circuit, for halting writing of the data at a stopping point prior to an end of the optical disc; a detector for evaluating the data recorded on the optical disc for generating a first evaluating result; a power characteristic control circuit, electrically connected to the detector and the laser modulating circuit, for adjusting the characteristic of the write power outputted from the laser according to the first evaluating result; and a recording starter, electrically connected to the laser modulating circuit, for driving the laser modulating circuit to restart writing data onto the optical disc from a starting point according to an adjusted characteristic of the write power, wherein the starting point is located between the stopping point and the end of the optical disc, and there is a gap between the starting point and the stopping point.

According to the claimed invention, a laser power controlling apparatus for controlling power outputted from a laser to record data onto an optical disc is disclosed. The laser power control apparatus comprises a laser modulating circuit, electrically connected to the laser, for driving the laser to write data onto the optical disc according to a characteristic of a write power outputted from the laser, and an optimum power calibration circuit. The optimum power calibration circuit comprises a driving unit, electrically connected to the laser modulating circuit, for driving the laser modulating circuit to write a plurality of test data on a optical disc according to a plurality of candidate power characteristics; an evaluating unit for evaluating, respectively, the test data recorded on the optical disc corresponding to the candidate power characteristics, to generate a first evaluating result; and a controlling unit, electrically connected to the evaluating unit, for selecting one of the candidate power characteristics to be a characteristic of a write power according to the first evaluating result, wherein the plurality of candidate power characteristics and the characteristic of the write power are utilized to determine an overdrive power.

In summary, the claimed invention provides a method and the related apparatus capable of determining characteristics of over drive power in the OPC procedure and adjust the characteristic of the write power on line by dynamically stopping the laser to more precisely evaluate the data recorded on the optical disc. As a result, the optimum power is adjusted more accurately.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a related art incident write pulse.

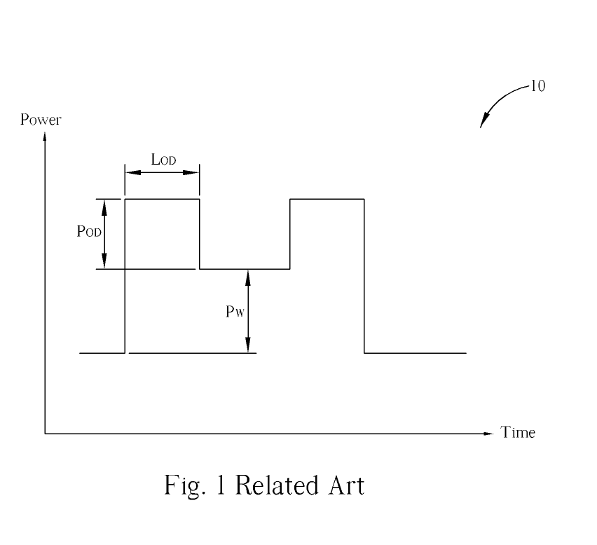

FIG. 2 is a flow chart of a laser power controlling method according to an embodiment of the present invention.

FIG. 3 is a flow chart of an improved OPC procedure shown in FIG. 2.

FIG. 4 is a diagram of a relationship between different candidate OD powers and jitter.

FIG. 5 is a diagram of a relationship between different candidate OD lengths and jitter.

FIG. 6 is a block diagram of a laser power controlling apparatus according to an embodiment of the present invention.

FIG. 7 is a schematic diagram of an optical disc shown in FIG. 6 according to the present invention.

FIG. 8 is a diagram of the compensated optimum power and the asymmetry parameter.

### DETAILED DESCRIPTION

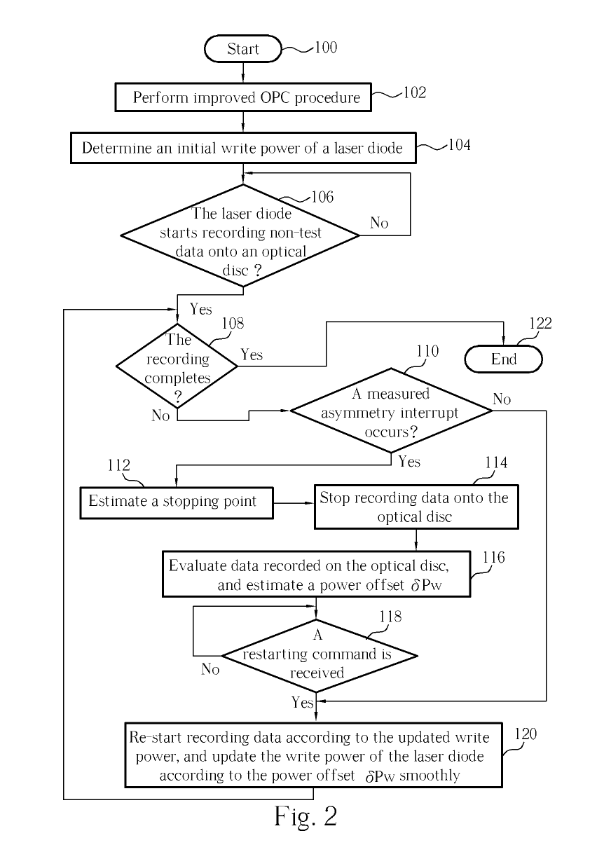

Please refer to FIG. 2. FIG. 2 is a flow chart of the laser power controlling method according to an embodiment of the present invention. The laser power controlling method is applied to an optical disc recorder, such as a DVD recorder, for controlling a laser diode of the optical disc recorder. The details of this embodiment are shown as follows.

Step 100: Start.

Step 102: Perform improved Optimum Power Calibration (OPC) procedure.

Step 104: Determine an initial write power of a laser diode according to the result of the OPC procedure.

Step 106: If the laser diode starts recording non-test data (i.e., the actual data) onto an optical disc, proceed to step 108; otherwise, repeat step 106.

Step 108: If the recording completes, proceed to step 122; otherwise, proceed to step 110.

Step 110: If a measured asymmetry interrupt occurs, proceed to step 112; otherwise, proceed to step 120.

Step 112: Estimate a stopping point prior the end of the optical disc.

Step 114: Turn off the laser diode when the laser diode reaches the stopping point and stop recording data onto the optical disc.

Step 116: Evaluate data recorded on the optical disc and estimate a power offset δP_{W} according to the evaluation result.

Step 118: Determine if a restarting command is received. If yes, proceed to step 120; otherwise, repeat step 118.

Step 120: Re-start recording data according to the updated write power, smoothly (i.e., slowly and gradually) update the write power of the laser diode according to the power offset δP_{W}, and then proceed to step 108.

Step 122: End.

Please refer to FIG. 2. FIG. 2 shows that the laser power controlling method first performs an improved OPC procedure to obtain the initial write power of the laser diode (steps 100, 102, and 104). When starting recording of non-test data onto the optical disc, the laser power controlling method estimates a stopping point after a measured asymmetry interrupt occurs, and the laser diode stops recording data at the stopping point (steps 110, 112, and 114). When the laser diode stops emitting the laser beam, the laser power controlling method evaluates an asymmetric parameter βₙ of the just recorded data to estimate a power offset δP_{W} (step 116). Please note that the operation of generating the power offset δP_{W} is detailed in the following paragraphs. In addition, the laser power controlling method further generates a smoothed power offset δP_{W}′ according to and compensating for the power offset δP_{W} in order to achieve the optimum power P_{W}. The smoothed power offset δP_{W}′, which tunes the optimum power P_{W}, gradually approaches the target power offset δP_{W}. The optimum power P_{W} of the laser diode is achieved by smoothly changing the power offset δP_{W}′. The operation for compensating the optimum power P_{W} is also detailed in the following paragraphs.

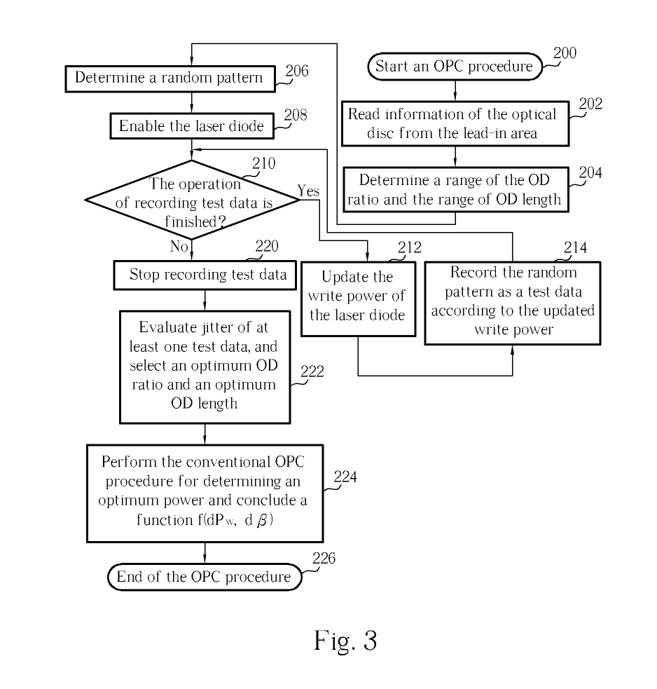

Please refer to FIG. 3. FIG. 3 is a flow chart of the improved OPC procedure shown in FIG. 2 (step 102). The details of the OPC procedure are described as follows.

Step 200: Start an OPC procedure.

Step 202: Read information of the optical disc, such as reference optimum power P_{W,ref}, reference OD ratio λ_{ref}, reference OD length L_{OD,ref}, and the predetermined asymmetric parameter βₜ from the lead-in area of the optical disc.

Step 204: Determine a range of the OD ratio (λᵤₚ, λ_{down}) and the range of OD length (L_{OD,down}, L_{OD,up}).

Step 206: Determine a random pattern.

Step 208: Enable the laser diode.

Step 210: If the operation of recording test data is finished, proceed to step 220; otherwise, proceed to step 212.

Step 212: Update the write power of the laser diode according to a plurality of candidate power characteristics.

Step 214: Utilize the laser diode to record the random pattern as a test data onto the optical disc according to the updated write power.

Step 220: Stop recording test data and turn off the laser diode.

Step 222: Evaluate jitter of at least one test data, and select an optimum OD ratio and an optimum OD length from the tested OD ratios and the tested OD lengths according to the evaluation result.

Step 224: Perform the conventional OPC procedure for determining an optimum power and conclude a function f(δP_{W}, δβ) defining a relationship between a delta write power δP_{W} and a delta asymmetric parameter δβ.

Step 226: End of the OPC procedure.

In this embodiment, the improved OPC procedure first utilizes the reference write power P_{W,ref}, the reference OD ratio λ_{ref}, the reference OD length L_{ref}, and the predetermined asymmetric parameter βₜ of the optical disc from the lead-in area (steps 200 and 202). Additionally, the improved OPC procedure determines the range of the OD ratio (λᵤₚ, λ_{down}) and the range of the OD length (L_{OD,down}, L_{OD,up}) for calibrating the OD power and OD length of the write power (step 204). In this embodiment, based on the determined range of the OD ratio (λᵤₚ, λ_{down}), the improved OPC procedure selects 15 candidate power characteristics corresponding to 15 OD powers P_{OD,m}. These candidate OD powers P_{OD,m} are generated according to the following equation:

$${P}_{OD , m} = {P}_{W} * {λ}_{down} + {P}_{W} * \frac{m}{15} * ( {λ}_{up} - {λ}_{down} ) \qquad Equation ( 1 )$$

Equation (1)

Referring to Equation (1), m is an integer between 0 and 14. Based on the determined range of the OD length (L_{OD,down}, L_{OD,up}), this embodiment also selects another 15 candidate power characteristics corresponding to 15 candidate OD lengths L_{OD,m}. These candidate OD lengths L_{OD,m} are generated according to the following equation:
L_{OD,m}=L_{OD,down}+m/15*(L_{OD,up}−L_{OD,down}) Equation (2)

Next, the improved OPC procedure writes the test data according to the candidate power characteristics, respectively, and evaluates jitter of the test data recorded on the optical disc. Finally, the improved OPC procedure selects two characteristics of the write power according to the above-mentioned candidate OD powers P_{OD,m} and candidate OD lengths L_{OD,m} (steps 208, 210, 212, 214, 220, and 222). The operation of selecting these two characteristics of the write power is detailed as follows.

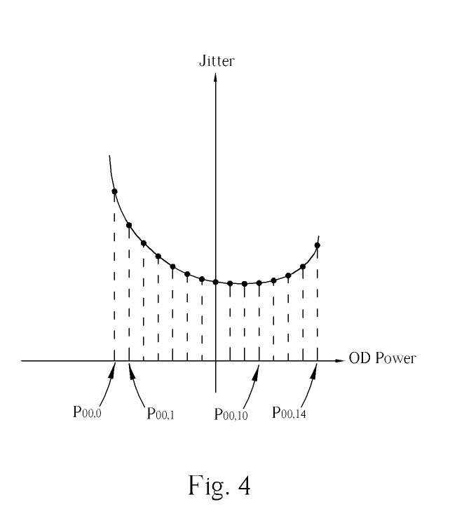

Please refer to FIG. 4. FIG. 4 is a diagram of a relationship between different candidate OD powers P_{OD,0}˜P_{OD,14} and jitter. As shown in FIG. 4, these candidate OD powers P_{OD,0}˜P_{OD,14} correspond to different test data, which have different jitter respectively. The candidate OD power P_{OD,10,} which corresponds to a minimum jitter, is deemed an optimum OD power P_{OD,opt}. As a result, a characteristic of the write power related to the optimum OD power P_{OD,opt} is selected.

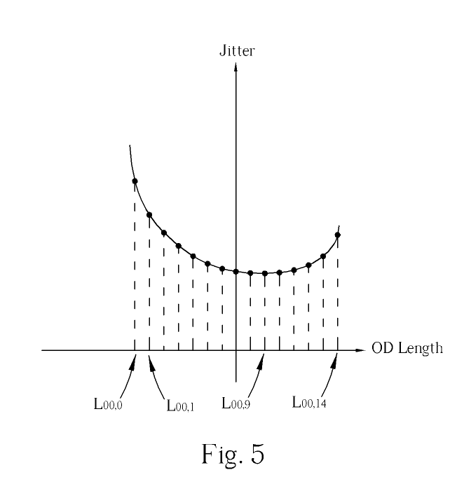

Please refer to FIG. 5. FIG. 5 is a diagram of various candidate OD lengths L_{OD,0}˜-L_{OD,14}. As shown in FIG. 5, these candidate OD lengths L_{OD,0}˜L_{OD,14} correspond to different test data, which have different jitter respectively. The candidate OD length L_{OD,9} corresponding to a minimum jitter is deemed an optimum OD length L_{OD,opt}. The other characteristic of the write power related to the optimum OD length L_{OD,opt} is selected in the same manner. Please note that the improved OPC procedure is also capable of determining other characteristics of the write power, besides the OD power and OD length, by utilizing the above-mention method.

After determining the optimum OD length L_{OD,opt} and optimum OD power P_{OD,opt}, the conventional OPC procedure obtains the optimum power P_{W} of the write power, and concludes the function f(δP_{W}, δβ) needed by step 11 6 shown in FIG. 2 (steps 224 and 226). Please note that the number of candidate OD powers and the number of candidate OD lengths are not limited to 15. In addition, the candidate power characteristics are not limited to the above-mentioned OD power and OD length.

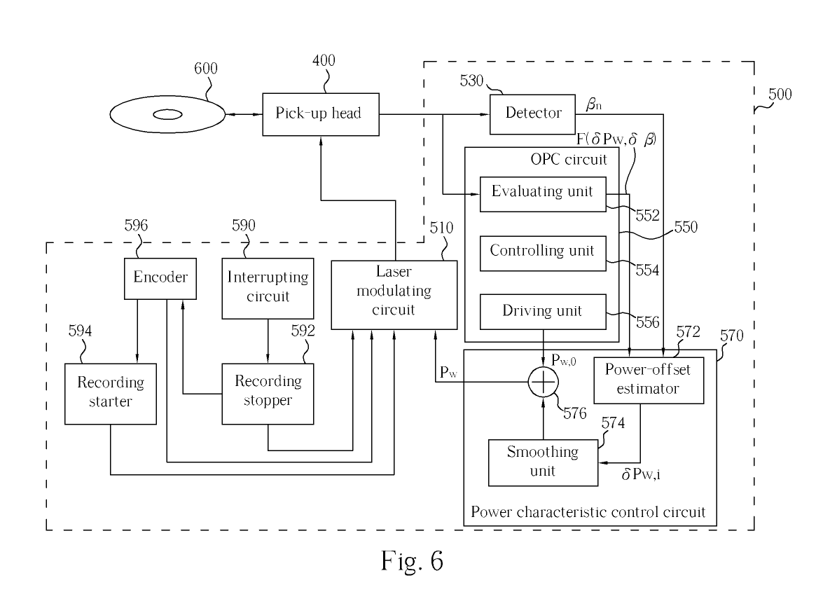

Please refer to FIG. 6. FIG. 6 is block diagram of a laser power controlling apparatus 500 according to a preferred embodiment of the present invention. The laser power controlling apparatus 500 is utilized to control a write power of a laser diode positioned on the pick-up head 400 for recording data onto an optical disc 600. As shown in FIG. 6, the laser power controlling apparatus 500 comprises a laser modulating circuit 510, a detector 530, an OPC circuit 550, a power characteristic control circuit 570, an interrupting circuit 590, a recording stopper 592, and a recording starter 594, and an encoder 596. In this embodiment, the laser modulating circuit 510 is utilized to drive the laser diode of the pick-up head 400 according to a plurality of characteristics of the write power (e.g., the optimum power P_{W}, OD power, and OD length) and special commands (e.g., the stopping command and restarting command). The encoder 596 transmits the encoded data to the laser modulating circuit 510, so the laser modulating circuit 510 is capable of driving the laser diode to write the encoded data onto the optical disc 600.

The OPC circuit 550 is utilized to generate an initial optimum power P_{W,0} and comprises an evaluating unit 552, a controlling unit 554, and a driving unit 556. In this embodiment, the driving unit 556 first generates a plurality of candidate power characteristics utilized for determining the optimum power, the OD power, or the OD length, and drives the laser modulating circuit 510 to write a plurality of test data according to these candidate power characteristics (steps 210˜214 shown in FIG. 3). Next, the evaluating unit 552 evaluates jitter of those test data for generating an evaluating result to the controlling unit 554 (step 222 shown in FIG. 3) and informs the power characteristic control circuit 570 of a function f(δP_{W}, δβ) (step 224 shown in FIG. 3). The controlling unit 554 selects at least one characteristic of the write power from the candidate power characteristics according to the evaluating result (step 222 shown in FIG. 3). For example, the power characteristic control circuit 570 selects a characteristic of the write power to determine the OD power of the write power and selects another characteristic of the write power to determine the OD length of the write power. Please note that the evaluating unit 552 is not limited to evaluating jitter of the test data. For instance, the evaluating unit 552 can also be utilized to evaluate error rates or asymmetry parameters.

The interrupting circuit 590, the recording stopper 592, and the recording starter 594 operate when the pick-up head 400 is recording data. When the interrupting circuit 590 generates a measured asymmetry interrupt to the recording stopper 592 (step 110 shown in FIG. 2), the recording stopper 592 estimates a stopping point, and drives the encoder 596 to generate a special pattern to the laser modulating circuit 510. After the special pattern has been written onto the optical disc 600, the recoding stopper 592 drives the laser modulating circuit 510 to stop the laser diode at the stopping point (steps 112 and 114 shown in FIG. 2). Next, the encoder 596 estimates a starting point according to the stopping point, and derives the recording starter 594 sends a restarting command to the laser modulating circuit 510 (step 118 shown in FIG. 2), in order to drive the laser diode to continue recording data from the starting point according to an adjusted optimum power P_{W} (step 120 shown in FIG. 2).

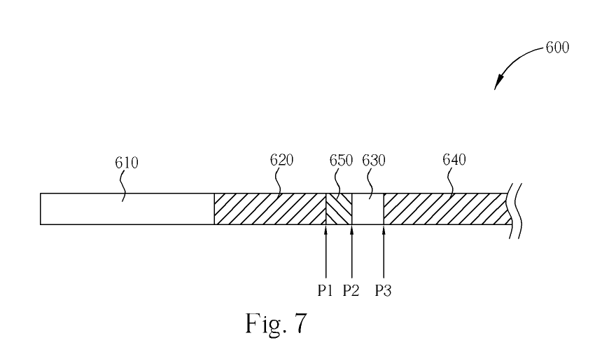

Please refer to FIG. 7. FIG. 7 is a schematic diagram of the optical disc 600 shown in FIG. 6. The optical disc 600 comprises a lead-in area 610, a plurality of data areas 620 and 640, a blank area 630, and a special pattern area 650. Firstly, the laser diode writes data into the data area 620. After the interrupting circuit 590 generates a measured asymmetry interrupt to the recording stopper 592, the recording stopper 592 estimates the points P1 and P2 then drives the encoder 596 to generate a special patent to the Laser modulating circuit 510. Next, the pick-up head 400 writes the special pattern from the point of P1 to the stopping point P2, and stops at the stopping point P2. As the special pattern is generated, the encoder 596 also evaluates a starting point P3. After the laser power is appropriately tuned, the recording starter 594 derives the pick-up head 400 restarts writing data onto the data area 640 from the starting point P3. As a result, the laser beam coming from the pick-up head 400 does not encounter the blank area 630. Please note that the length of the blank area 630 is nT (i.e., the distance between the starting point P3 and the stopping point P2), wherein n is a predetermined value, and T relates to the writing frequency of the pick-up head 400. Besides, the length of the special pattern is mT. The special pattern is utilized to replace the original EFM signal, and helps the pick-up head 400 get the starting point P3 when re-starting recording data. In addition, the blank area 630 separate the data stored in the data area 620 and 640, so the data stored in the data area 620 will not be affected when the laser diode restarts recording data into the data area 640 closed to the data area 620.

In this embodiment, the detector 530 shown in FIG. 6 is utilized to evaluate an asymmetry parameter βₙ of the latest data recorded in the data area 620 when the laser diode was stopped at the stopping point P2 by the recording stopper 594. The power characteristic control circuit 570 computes a power offset δP_{W} according to the asymmetry parameter βₙ for compensating the optimum power of the laser diode (step 116 shown in FIG. 2). The power offset δP_{W} is generated by utilizing the asymmetric parameter βₙ and the predetermined asymmetric parameter βₜ and the function f(δP_{W}, δβ) generated by the OPC circuit 550. The power characteristic control circuit 570 comprises a power-offset estimator 572, a smoothing unit 574, and a compensating unit 576. The power-offset estimator 572 first computes the power offset bPw according to the following equation:
δP_{W,n}=Kp·(βₙ−βₜ)f(δP_{W,n},δβ) Equation (3)

Concerning equation (3), n denotes the index of the power offset, Kp denotes a parameter utilized for adjusting the power offset δP_{W,n}, and f(δP_{W}, δβ) determined by OPC circuit denotes the ratio of the write power offset δP_{W} to the asymmetry offset δβ according to the present embodiment. Please note that the operation of the power-offset estimator 572 is not limited to the Equation (3), other reasonable modifications of Equation (3) are covered by the present invention. Next, the smoothing unit 574 generates a smoothed power offset δP_{W,n}′ by utilizing the power offset δP_{W,n} according to the following equation:
δP_{W,n}′=δP_{W,n}+g(δP_{W,n},δT) Equation (4)

Concerning the equation (4), the function g(δP_{W,n},δT) denotes the operation of the smoothing unit 574, and δT relates to the updating frequency. For example, the smoothing unit 574 can use the linear interpolation as the following equation:

$$δ {{P}_{W , n}}^{′} = δ {P}_{W , n} + \frac{δ {P}_{W , n}}{i} * j \qquad Equation ( 5 )$$

In Equation (5), i denotes the total power update steps and j is a positive integer between zero to i-1. Consequently, the compensating unit 576 compensates the optimum power P_{W,n} by adding the smoothed power offset δP_{W,n}′ to the optimum power P_{W,n} according to the following equation:
P_{W,n}=P_{Own-1}+δ_{W,n}′ Equation (6)

Concerning Equation (6), the optimum write power P_{W,n} will be updated to the laser modulating circuit 510 continuously after the recording starter 594 enables the laser diode (step 120 shown in FIG. 2).

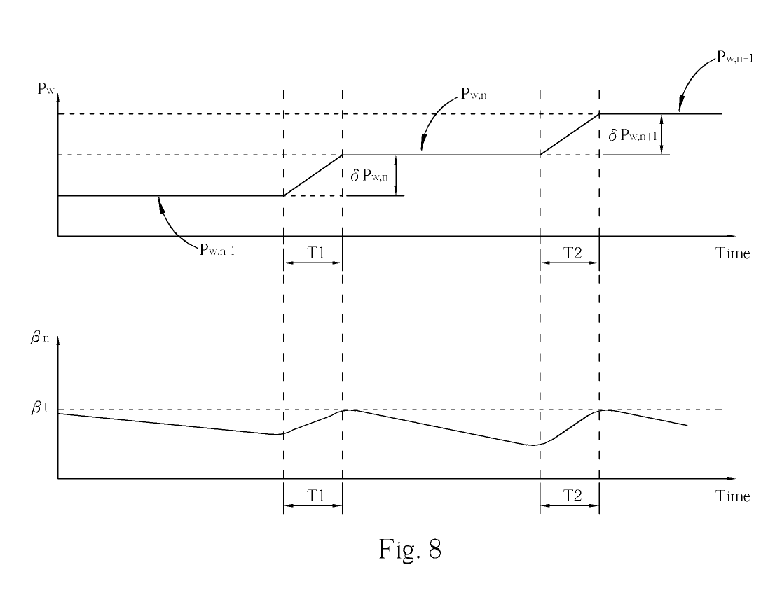

Please refer to FIG. 8. FIG. 8 is a diagram of the compensated optimum power P_{W} and the asymmetry parameter βₙ. As shown in FIG. 8, the optimum powers δP_{W,n-1} and P_{W,n} are compensated smoothly during the time intervals T1 and T2 (step 120 shown in FIG. 2) according to the power offsets δP_{W,n} and δP_{W,n+1}, respectively. As a result, the asymmetry parameter βₙ corresponding to the optimum power P_{W} is improved gradually in the time intervals T1 and T2. Although the power characteristic control circuit 570 compensates the optimum power linearly in this embodiment, other related art compensating schemes can also be utilized.

In contrast to the related art, the present invention provides an improved OPC procedure and a corresponding OPC circuit not only to determine the optimum power, but also to determine the OD power, the OD length, and other characteristics of the write power. Additionally, the present invention provides a power characteristic control circuit and a corresponding method for adjusting the optimum power on-line making power tuning more precise than the related art ROPC procedure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A laser power controlling method for controlling power outputted from a laser to record data onto an optical disc, the laser power controlling method comprising:
writing data onto the optical disc according to a characteristic of an write power outputted from the laser;
halting writing the data at a stopping point prior to an end of the optical disc;
evaluating the data recorded on the optical disc for generating a first evaluating result;
adjusting the characteristic of the write power outputted from the laser according to the first evaluating result; and
utilizing the laser to restart writing data onto the optical disc from a starting point according to an adjusted characteristic of the write power;
wherein the starting point is located between the stopping point and the end of the optical disc and there is a gap between the starting point and the stopping point.

2. The laser power controlling method of claim 1, wherein the step of writing data onto the optical disc further comprises:
generating a special pattern; and
writing the special pattern onto the optical disc to replace an EFM signal.

3. The laser power controlling method of claim 1 further comprising:
determining the characteristic of the write power before writing the data onto the optical disc.

4. The laser power controlling method of claim 3, wherein the step of determining the characteristic of the write power comprises:
writing a plurality of test data on the optical disc according to a plurality of candidate power characteristics, respectively;
evaluating the test data recorded on the optical disc corresponding to the candidate power characteristics, respectively, to generating a second evaluating result; and
selecting one of the candidate power characteristics to be the characteristic of the write power according to the second evaluating result.

5. The laser power controlling method of claim 4, wherein the characteristic of the write power and the candidate power characteristics are utilized to determine overdrive power and the related overdrive ratio.

6. The laser power controlling method of claim 4, wherein the characteristic of the write power and the candidate power characteristics are utilized to determine overdrive length.

7. The laser power controlling method of claim 4, wherein the step of evaluating the test data comprises evaluating jitter of the test data recorded on the optical disc to generate the second evaluating result.

8. The laser power controlling method of claim 4, wherein the step of evaluating the test data comprises evaluating asymmetry parameters of the test data recorded on the optical disc to generate the second evaluating result.

9. The laser power controlling method of claim 1, wherein the step of evaluating the data comprises:
evaluating an asymmetry parameter corresponding to the data recorded on the optical disc to generate the first evaluating result.

10. The laser power controlling method of claim 8, wherein the step of adjusting the characteristic of the write power comprises:
computing a power offset according to a predetermined asymmetry parameter and the asymmetry parameter; and
adjusting the characteristic of the write power according to the power offset for compensating the optimum power.

11. The laser power controlling method of claim 10, wherein the step of compensating the optimum power comprises:
smoothing the power offset to generate a smoothed power offset; and
adding the smoothed power offset to the optimum power for adjusting the characteristic of the write power.

12. The laser power controlling method of claim 1, wherein the step of halting writing the data at the stopping point comprises:
receiving a stopping command;
estimating the stopping point; and
halting writing the data at the stopping point.

13. A laser power control method for controlling power outputted from a laser to record data onto an optical disc, the laser power controlling method comprising:
writing a plurality of test data on a optical disc according to a plurality of candidate power characteristics, respectively;
evaluating the test data recorded on the optical disc corresponding to the candidate power characteristics, respectively, to generate a first evaluating result;
selecting one of the candidate power characteristics to be a characteristic of an write power according to the first evaluating result; and
writing data onto the optical disc according to the characteristic of the write power outputted from the laser,
wherein the plurality of candidate power characteristics and the characteristic of the write power are utilized to determine an overdrive power.

14. The laser power control method of claim 1 3, wherein the characteristic of the write power and candidate power characteristics are utilized to determine a magnitude of the overdrive power.

15. The laser power control method of claim 13, wherein the characteristic of the write power and candidate power characteristics are utilized to determine an overdrive length.

16. The laser power control method of claim 13, wherein the step of evaluating the test data comprises evaluating jitter of the test data recorded on the optical disc to generate the first evaluating result.

17. The laser power control method of claim 13, wherein the step of evaluating the test data comprises evaluating asymmetry parameters of the test data recorded on the optical disc to generate the first evaluating result.

18. The laser power control method of claim 13 further comprising:
halting writing the data at a stopping point prior to an end of the optical disc;
evaluating the data recorded on the optical disc for generating a second evaluating result;
adjusting the characteristic of the write power outputted from the laser according to the second evaluating result; and
utilizing the laser to restart writing the data onto the optical disc from a starting point according to an adjusted characteristic of the write power;
wherein the starting point is located between the stopping point and the end of the optical disc, and there is a gap between the starting point and the stopping point.

19. The laser power control method of claim 18, wherein the step of writing data onto the optical disc further comprises:
generating a special pattern; and
writing the special pattern onto the optical disc to replace an EFM signal.

20. The laser power control method of claim 18, wherein the step of evaluating the data comprises:
evaluating an asymmetry parameter corresponding to the data recorded on the optical disc to generate the second evaluating result.

21. The laser power control method of claim 20, wherein the step of adjusting the characteristic of the write power comprises:
computing a power offset according to a predetermined asymmetry parameter and the asymmetry parameter; and
adjusting the characteristic of the write power according to the power offset for compensating the optimum power.

22. The laser power control method of claim 21, wherein the step of compensating the optimum power comprises:
smoothing the power offset to generate a smoothed power offset; and
adding the smoothed power offset to the optimum power for adjusting the characteristic of the write power.

23. The laser power controlling method of claim 13, wherein the step of halting writing the data at the stopping point comprises:
receiving a stopping command;
estimating the stopping point; and
halting writing the data at the stopping point.

24. A laser power controlling apparatus for controlling power outputted from a laser to record data onto an optical disc, the laser power controlling apparatus comprising:
a laser modulating circuit, electrically connected to the laser for driving the laser to write data onto the optical disc according to a characteristic of a write power outputted from the laser;
a recording stopper, electrically connected to the laser modulating circuit, for halting writing the data at a stopping point prior to an end of the optical disc;
a detector for evaluating the data recorded on the optical disc for generating a first evaluating result;
a power characteristic control circuit, electrically connected to the detector and the laser modulating circuit, for adjusting the characteristic of the write power outputted from the laser according to the first evaluating result; and
a recording starter, electrically connected to the laser modulating circuit, for driving the laser modulating circuit to restart writing data onto the optical disc from a starting point according to an adjusted characteristic of the write power,
wherein the starting point is located between the stopping point and the end of the optical disc and there is a gap between the starting point and the stopping point.

25. The laser power controlling method of claim 24, wherein the laser power controlling apparatus further comprises:
an encoder, electrically connected to the recording stopper, for generating a special pattern an control signal outputted by the recording stopper, and for determining the starting point utilized by the recording starter; and
wherein the laser modulating circuit drives the laser to write the special pattern onto the optical disc to replace an EFM signal.

26. The laser power controlling apparatus of claim 24, wherein the laser power control apparatus further comprises:
a optimum power calibration circuit(OPC circuit), electrically connected to the laser modulating circuit, for determining the characteristic of the write power before writing the data onto the optical disc.

27. The laser power controlling apparatus of claim 26, wherein the optimum power calibration circuit comprises:
a driving unit, electrically connected to the laser modulating circuit, for driving the laser modulating circuit to write a plurality of test data onto the optical disc according to a plurality of candidate power characteristics, respectively;
an evaluating unit, for evaluating the test data recorded on the optical disc corresponding to the candidate power characteristics, respectively, to generate a second evaluating result; and
a controlling unit, electrically connected to the evaluating unit, for selecting one of the candidate power characteristics to be the characteristic of the write power according to the second evaluating result.

28. The laser power controlling apparatus of claim 27, wherein the characteristic of the write power and the candidate power characteristics are utilized to determine overdrive power.

29. The laser power controlling apparatus of claim 27, wherein the characteristic of the write power and the candidate power characteristics are utilized to determine overdrive length.

30. The laser power controlling apparatus of claim 27, wherein the evaluating unit is utilized to evaluate jitter of the test data recorded on the optical disc to generate the second evaluating result.

31. The laser power controlling apparatus of claim 27, wherein the evaluating unit is utilized to evaluate asymmetry parameters of the test data recorded on the optical disc to generate the second evaluating result.

32. The laser power controlling apparatus of claim 24, wherein the detector is utilized for evaluating an asymmetry parameter corresponding to the data recorded on the optical disc to generate the first evaluating result.

33. The laser power controlling apparatus of claim 32, wherein the power characteristic control circuit comprises:
a power offset estimator for computing a power offset according to a predetermined asymmetry parameter and the asymmetry parameter; and
a compensating unit for adjusting the characteristic of the write power according to the power offset to compensate the optimum power.

34. The laser power controlling apparatus of claim 33, wherein the power characteristic control circuit further comprises:
a smoothing unit for smoothing the power offset to generate a smoothed power offset,
wherein the compensating unit add the smoothed power offset to the characteristic of the write power for adjusting the characteristic of the write power.

35. The laser power controlling apparatus of claim 24, wherein after the recording stopper receiving an interrupt command, the recording stopper estimates the stopping point, and halting writing the data at the stopping point.

36. A laser power controlling apparatus for controlling power outputted from a laser to record data onto an optical disc, the laser power control apparatus comprising:
a laser modulating circuit, electrically connected to the laser, for driving the laser to write data onto the optical disc according to a characteristic of an write power outputted from the laser; and
an optimum power calibration circuit comprising:
a driving unit, electrically connected to the laser modulating circuit, for driving the laser modulating circuit to write a plurality of test data on a optical disc according to a plurality of candidate power characteristics, respectively;
an evaluating unit for evaluating the test data recorded on the optical disc corresponding to the candidate power characteristics, to generate a first evaluating result; and
a controlling unit, electrically connected to the evaluating unit, for selecting one of the candidate power characteristics to be a characteristic of an write power according to the first evaluating result,
wherein the plurality of candidate power characteristics and the characteristic of the write power are utilized to determine an overdrive power.

37. The laser power controlling apparatus of claim 36, wherein the characteristic of the write power and the candidate power characteristics are utilized to determine the magnitude of the overdrive power.

38. The laser power controlling apparatus of claim 36, wherein the characteristic of the write power and the candidate power characteristics are utilized to determine overdrive length.

39. The laser power controlling apparatus of claim 36, wherein the evaluating unit is utilized to evaluate jitter of the test data recorded on the optical disc to generate the first evaluating result.

40. The laser power controlling apparatus of claim 36, wherein the evaluating unit is utilized to evaluate asymmetry parameters of the test data recorded on the optical disc to generate the first evaluating result.

41. The laser power controlling apparatus of claim 36 further comprising:
a recording stopper, electrically connected to the laser modulating circuit, for driving the laser modulating circuit to halt writing the data at a stopping point prior to an end of the optical disc;
a detector for evaluating the data recorded on the optical disc for generating a second evaluating result;
a power characteristic control circuit, electrically connected to the detector and the laser modulating circuit, for adjusting the characteristic of the write power outputted from the laser according to the second evaluating result; and
a recording starter, electrically connected to the laser modulating circuit, for driving the laser modulating circuit to restart writing data onto the optical disc from a starting point according to an adjusted characteristic of the write power,
wherein the starting point is located between the stopping point and the end of the optical disc, and there is a gap between the starting point and the stopping point.

42. The laser power controlling method of claim 41 further comprising:
an encoder, electrically connected to the recording stopper, for generating a special pattern an control signal outputted by the recording stopper, and for determining the starting point utilized by the recording starter; and
wherein the laser modulating circuit drives the laser to write the special pattern onto the optical disc to replace an EFM signal.

43. The laser power controlling apparatus of claim 41, wherein the detector is utilized to evaluate an asymmetry parameter corresponding to the data recorded on the optical disc to generate the second evaluating result.

44. The laser power controlling apparatus of claim 43, wherein the power characteristic control circuit further comprises:
a power offset estimator for computing a power offset according to a predetermined asymmetry parameter and the asymmetry parameter; and
a compensating unit for adjusting the characteristic of the write power according to the power offset in order to compensate the optimum power.

45. The laser power controlling apparatus of claim 44, wherein the overdrive power characteristic control circuit further comprises:
a smoothing unit for smoothing the power offset to generate a smoothed power offset,
wherein the compensating unit adjusting the characteristic of the write power by adding the smoothed power offset to the optimum power.

46. The laser power controlling apparatus of claim 41, wherein after the recording stopper receiving a stopping command, the recording stopper estimates the stopping point, and halts writing the data at the stopping point.
